(19) United States
(12) Patent Application Publication
(10) Pub. No.: US 2019/0208301 A1
(43) Pub. Date: Jul. 4, 2019

(54) AUDIO DEVICE WITH ACOUSTIC VALVE

(71) Applicant: Knowles Electronics, LLC, Itasca, IL (US)

(72) Inventors: Christopher Monti, Elgin, IL (US); Shehab Albahri, Hanover Park, IL (US); Charles King, Oak Park, IL (US); Christopher Jones, Carpentersville, IL (US)

(21) Appl. No.: 16/236,375

(22) Filed: Dec. 29, 2018

Related U.S. Application Data
(60) Provisional application No. 62/611,790, filed on Dec. 29, 2017.

(51) Int. Cl. H04R 1/10; H04R 25/00; H04R 11/02

(52) U.S. Cl. CPC H04R 1/1016; H04R 1/1075; H04R 2225/025; H04R 11/02; H04R 2460/11; H04R 25/652

(57) ABSTRACT

A hearing device such as a hearing aid or other type of wearable includes an acoustic transducer operable to produce sound, a housing with a sound opening which contains the acoustic transducer, an acoustic vent defined at least partially by a portion of the transducer, and an actuatable acoustic valve disposed along the acoustic vent.

### RELATED APPLICATIONS

This application relates to U.S. Provisional Patent Application Ser. No. 62/611,790 filed on Dec. 29, 2017, and entitled “Audio Device with Acoustic Valve,” the entire contents of which is hereby incorporated by reference.

### TECHNICAL FIELD

This disclosure relates generally to audio devices and, more specifically, to audio devices that have different modes of operation.

### BACKGROUND

Audio devices are known generally and include hearing aids and earphones and ear pods, among other devices. Some audio devices are configured to provide an acoustic seal (i.e., “closed fit”) with the user's ear. The seal may cause occlusion, which is a sense of pressure build-up in the ear, and the perception of other negative effects such as blocking of externally produced sounds that the user may wish to hear and a distorted perception of one's own voice. However, closed fit devices have desirable effects including higher output at low frequencies and the blocking of unwanted noise from the ambient environment.

Other audio devices are permanently vented (i.e., “open fit”), which allows ambient sound to pass into the user's ear. Open-fit devices tend to reduce the negative effects of occlusion but in some circumstances may not provide optimized frequency performance and sound quality. One such open-fit hearing device is a receiver-in-canal (RIC) device that is fitted with an open fit ear dome. RIC devices typically supplement environmental sound with amplified sound in a specific range of frequencies to compensate for hearing loss and aid in communication. The inventors have recognized a need for hearing devices that can provide the benefits of both open fit and closed fit.

### BRIEF DESCRIPTION OF THE DRAWINGS

For a more complete understanding of the disclosure, reference should be made to the following detailed description and accompanying drawings wherein:

FIG. 1 is a diagram illustrating a hearing device located at least partially inside a user's ear canal;

FIG. 2 is a perspective view of a hearing device without an ear dome;

FIG. 3 is another perspective view of the hearing device shown in FIG. 2 with an ear dome attached;

FIG. 4 is a sectional diagram of the hearing device of FIG. 1 along line A-A and in the direction of arrow B in FIG. 1;

FIG. 5 is a sectional diagram of a hearing device without a partition in a forward acoustic housing portion;

FIG. 6 is a sectional diagram of a hearing device having an acoustic vent through a transducer;

FIG. 7 is a sectional diagram of another hearing device with an acoustic vent through the transducer;

FIG. 8 is a sectional diagram of a hearing device;

FIG. 9 is a sectional diagram of a hearing device;

FIG. 10 is a sectional view of another hearing device.

Elements in the figures are illustrated for simplicity and clarity and have not necessarily been drawn to scale or to include all features, options or attachments. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. The terms and expressions used herein have the ordinary technical meaning as is accorded to such terms and expressions by persons skilled in the technical field as set forth above except where different specific meanings have otherwise been set forth herein.

### DETAILED DESCRIPTION

The present disclosure pertains to hearing devices configurable between open fit and closed fit configurations at different times through actuation of one or more acoustic valves located in one or more vents between a portion of the hearing device that is disposed in or on a user's ear and another portion of the hearing device that is exposed to the environment. The valve may be actuatable in situ without having to remove the hearing device from the user's ear thereby enabling the user to experience the benefit of a closed fit or an open fit depending on the user's desire or other context.

The teachings of the present disclosure are generally applicable to hearing devices including a sound-producing electroacoustic transducer disposed in a housing having a portion configured to form a seal with the user's ear. The seal may be formed by an ear tip or other portion of the hearing device. In some embodiments, the hearing device is a receiver-in-canal (RIC) device for use in combination with a behind-the-ear (BTE) device including a battery and an electrical circuit. The RIC typically includes a sound-producing electro-acoustic transducer disposed in a housing having a portion configured for insertion at least partially into a user's ear canal. The BTE unit is electrically coupled to the RIC device by a wired connection that extends about the user's ear. In other embodiments, the hearing device is an in-the-ear (ITE) device or a completely-in-canal (CIC) device containing the transducer, electrical circuits and all other components. In another embodiment, the hearing device is a behind-the-ear (BTE) device containing the transducer, electrical circuits and other active components with a sound tube and other passive components that extends into the user's ear. The teachings of the present disclosure are also applicable to over-the-ear devices, earphones, ear buds, and ear pods, in-ear headphones with wireless connectivity, among other wearable devices that form a sealed coupling with the user's ear and emit sound thereto. These and other applicable hearing devices typically include an electro-acoustic transducer operable to produce sound although the teachings are also applicable to passive hearing devices devoid of an electro-acoustic transducer.

In embodiments that include an electro-acoustic transducer, the transducer generally includes a diaphragm that separates a volume within a housing of the hearing device into a front volume and a back volume. A motor actuates the diaphragm in response to an excitation signal applied to the motor. Actuation of the diaphragm moves air from a volume of the housing and into the user's ear via a sound opening of the hearing device. Such a transducer may be embodied as a balanced armature receiver or as a dynamic speaker among other known and future transducers.

According to one aspect of the disclosure, the hearing device includes an acoustic vent extending between a portion of the hearing device that is intended to be coupled to the user ear (e.g., disposed on the user's ear or at least partially in the ear canal) and a portion of the hearing device that is exposed to the environment, wherein the acoustic vent is defined at least partially by a portion of the transducer.

In some embodiments, the sound-producing transducer includes a transducer housing disposed within a housing of the hearing device. In one implementation, the acoustic vent of the hearing device is disposed between the transducer housing and the housing, such as an interior wall thereof, so that an outer surface of the transducer housing defines at least a portion of the acoustic vent. In some embodiments, the acoustic vent includes multiple discrete paths, wherein each vent path is defined at least partially by a corresponding portion of the transducer. Such paths may remain isolated or merge at one or both the valve or the sound opening of the housing.

In other embodiments, the acoustic vent passes through a front volume of the transducer, wherein a diaphragm of the transducer defines a portion of the acoustic vent. In this embodiment, the front volume is acoustically coupled to the sound opening of the housing and to a portion of the acoustic vent exposed to the environment. In some implementations, the housing constitutes at least a portion of the transducer housing. In other implementations, the housing and the transducer housing are one and the same.

Actuation of an acoustic valve disposed in or along the acoustic vent alters the passage of sound through the vent thereby configuring the hearing device between a relatively open fit state and a relatively closed fit state. When the acoustic valve is open, the pressure within the ear equalizes with the ambient air pressure outside the ear canal and at least partially allows the passage of low-frequency sound thereby reducing the occlusion effects that are common when the ear canal is fully blocked. Opening the acoustic valve also allows ambient sound outside the ear canal to travel through the sound passage and into the ear canal. Conversely, by closing the acoustic valve the device more completely isolates the user from external sounds and improves the low frequency acoustic output of the device which may be preferable for certain activities, such as listening to music.

The housing generally includes a forward acoustic housing portion defining the sound opening of the housing. A volume of the forward acoustic housing portion defines an acoustic path between the front volume and the sound opening of the housing. In some embodiments, the volume of the forward acoustic housing portion also defines a portion of the acoustic vent. The portions of the acoustic vent and the acoustic path formed by the forward acoustic housing may be coextensive or they may be separated by a physical divider, or by a combination thereof.

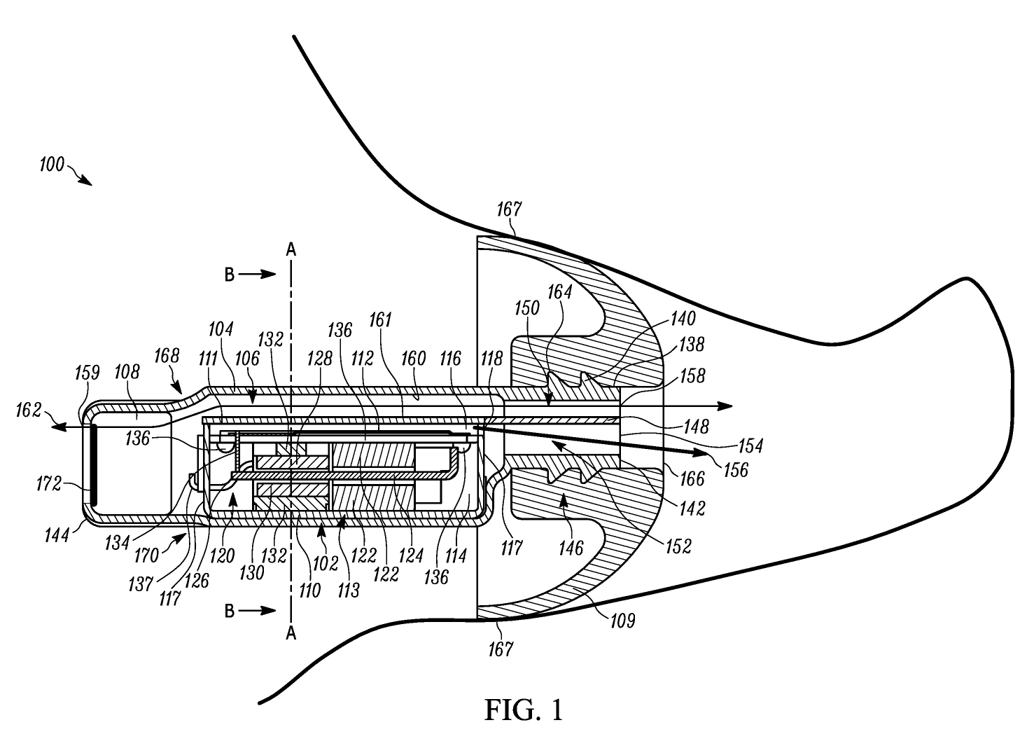

FIGS. 1-4 illustrate one example of a hearing device 100 in which an acoustic vent is disposed between a transducer housing and a housing of the hearing device. The hearing device 100 is a RIC or other device configured for insertion at least partially into the user's ear canal. The hearing device includes an ear tip or dome 109 or other structure that forms a seal with the ear canal. In this example, the hearing device 100 is made up of an acoustic transducer 102, a housing 104, an acoustic vent 106, an actuatable acoustic valve 108, and a close-fit ear dome 109.

In FIGS. 1-4, the acoustic transducer 102 includes a transducer housing 110, with a cover 111 and a cup 113. The acoustic transducer 102 is embodied as a balanced armature receiver including a diaphragm 112 which separates the inside volume of the transducer housing 110 into a back volume 114 and a front volume 116. The front volume 116 is partially defined by the cover 111 and the diaphragm 112. The transducer housing 110 is also made up of sidewalls 117 of the cup 113 attached to the cover 111. A sound port 118 disposed through the housing is acoustically coupled to the ear canal once the hearing device 100 is at least partially inserted into the ear canal. Also, the front volume 116 is acoustically coupled to the sound port 118. However, any suitable acoustic receiver may be employed.

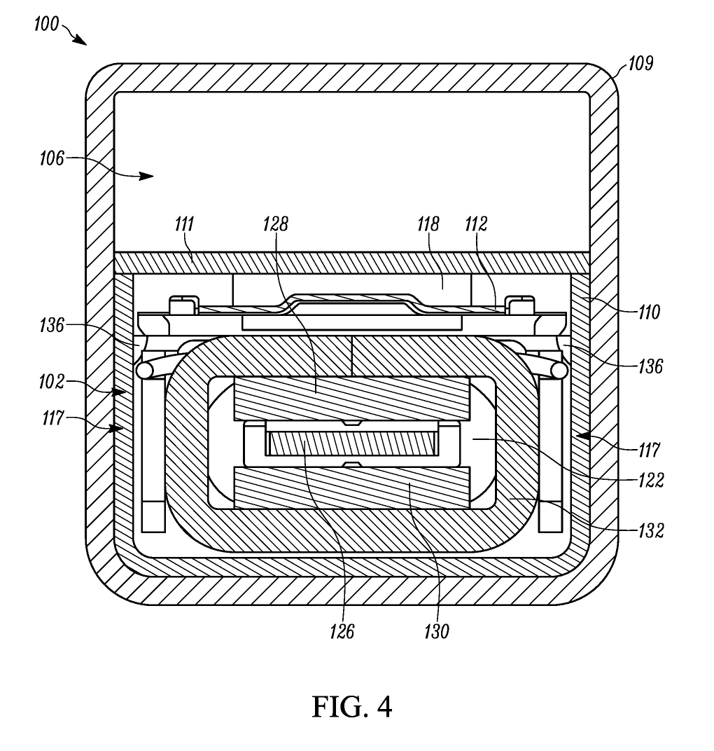

In FIGS. 1-4, the transducer 102 includes a motor 120 disposed in the back volume 114. The motor includes a coil 122 which is disposed about a portion of an armature 124, a movable portion 126 of which is disposed in equipoise between magnets 128 and 130. The magnets 128 and 130 are retained by a yoke 132. The movable portion 126 of the armature 124 is coupled to the diaphragm 112 by a rod 134 or other linkage. The diaphragm 112 is movably coupled to a support structure 136 of the transducer housing 110. In this example, the support structure 136 is a ring surrounding the diaphragm 112 which is a non-moving part supported by tabs formed in the housing 110, as shown in FIG. 4. An adhesive such as glue, which is not shown, seals the non-moving part of the diaphragm 112 to the transducer housing 110. Other suitable configurations for the support structure 136 may be employed as appropriate. Application of an excitation signal to the coil 122 modulates the magnetic field, causing deflection of the armature 124 between the magnets 128 and 130. Movement of the diaphragm 112 results in changes in air pressure in the front volume 116 wherein acoustic pressure (e.g., sound) is emitted through the sound port 118 of the transducer 102. Armature receivers suitable for the embodiments described herein are available from Knowles Electronics, LLC. In other embodiments, other types of electro-acoustic transducers may be employed. In RIC units configured for use with a BTE unit, interconnecting wires 137 transmit electrical signals that include, for example, a driving signal of the acoustic transducer 102 and an electrical current to change the state of the valve 108 between the open state and the closed state.

In FIGS. 1-4, the housing 104 includes a portion called a nozzle 138 which may have one or more barbs 140 to which the ear dome 109 is removable attached. The housing 104 also has a first portion 142 configured to at least partially be disposed in the user's ear canal and a second portion 144 on the opposite side coupled to the ambient atmosphere. Located adjacent to the first portion 142 is a forward acoustic housing portion 146. A partition 148 separates the forward acoustic housing portion 146 into a first volume 150 and a second volume 152. The partition 148 may be made up, at least in part, by the transducer housing 110, the housing 104, or by a separate component. The second volume 152 defines a sound opening 154 located on the first portion 142 of the housing 104. The second volume 152 also defines an acoustic path 156 (indicated with a single-headed arrow in FIG. 1) located between the sound port 118 of the transducer 102 and the sound opening 154 of the housing 104. As such, when the first portion 142 is at least partially disposed in the user's ear canal, sound from the front volume 116 emanates along the acoustic path 156 into the user's ear canal via the sound opening 154. The housing 104 can be made of any suitable material, such as metal or plastic, as appropriate.

Furthermore in this example, contoured transition portions 168 and 170, located between the transducer 102 and the valve 108, are formed in the housing 104 in any suitable shape to secure the valve 108 and allow airflow through the flow path 162 of the acoustic vent 106. Also, a filter 172 is mountable either internally within the housing 104 on either or both sides of the acoustic valve 108 In FIG. 1, the filter is disposed between the valve 108 and the second portion 144 of the housing 104, or externally for easy replacement. The filter 172 inhibits the migration of wax, particulate matter, fluid, vapor and other debris into the hearing device.

In FIG. 1, the acoustic vent 106 has a first port 158 and a second port 159, located to permit venting the user's ear canal to the ambient atmosphere. When the first portion of the hearing device is at least partially disposed in the user's ear canal, the first port 158 of the acoustic vent 106 is acoustically coupled to the ear canal, while the second port 159 of the acoustic vent 106 is coupled to the ambient atmosphere. The acoustic vent 106 is defined by the volume between the inside surface 160 of the housing 104 and the outer surface 161 of the transducer housing 110, as well as the first volume 150 of the forward acoustic housing portion 146 of the housing 104. A flow path 162 of the acoustic vent 106 is indicated with a double-headed arrow. The acoustic valve 108 is placed along the acoustic vent 106, so that when the acoustic valve 108 is actuated, the valve 108 can alter the passage of sound between the ear canal and the ambient atmosphere. Any suitable acoustic valve may be employed for the acoustic valve 108, including but not limited to the acoustic valve as disclosed in U.S. Pat. No. 8,798,304 assigned to Knowles Electronics, LLC.

In FIG. 1, the ear dome 109 has a set of notches 164 to accommodate the barbs 140. The ear dome 109 also has a portion 167 configured to contact a user's ear canal while the hearing device 100 is at least partially inserted into the ear. The sound opening 166 of the ear dome 109 is coupled to the sound opening 118 of the hearing device 100 when the nozzle 138 of the housing 104 is inserted through the sound opening 166 of the ear dome 109. As the nozzle 138 is inserted through the sound opening 166 of the ear dome 109, the notches 164 attach to the barbs 140 disposed along the nozzle 138 to prevent any inadvertent removal of the ear dome 109 from the device 100.

In FIG. 1, the ear dome forms a substantial acoustic seal to the ear canal once the hearing device is at least partially inserted into the ear canal, thereby substantially preventing leakage of sound from the ear canal to the ambient atmosphere. The ear dome 109 may be made of any material as deemed suitable for the use of the hearing device, including but not limited to foams, silicone, plastic, or rubber. Any suitable ear tip may be employed and different shapes of the ear domes may be employed, such as double- or triple-flanged ear domes, as appropriate, in order to provide a more isolating or more reliable acoustic seal for the user while the hearing device is at least partially inserted inside the ear canal. Any other suitable configurations may be used.

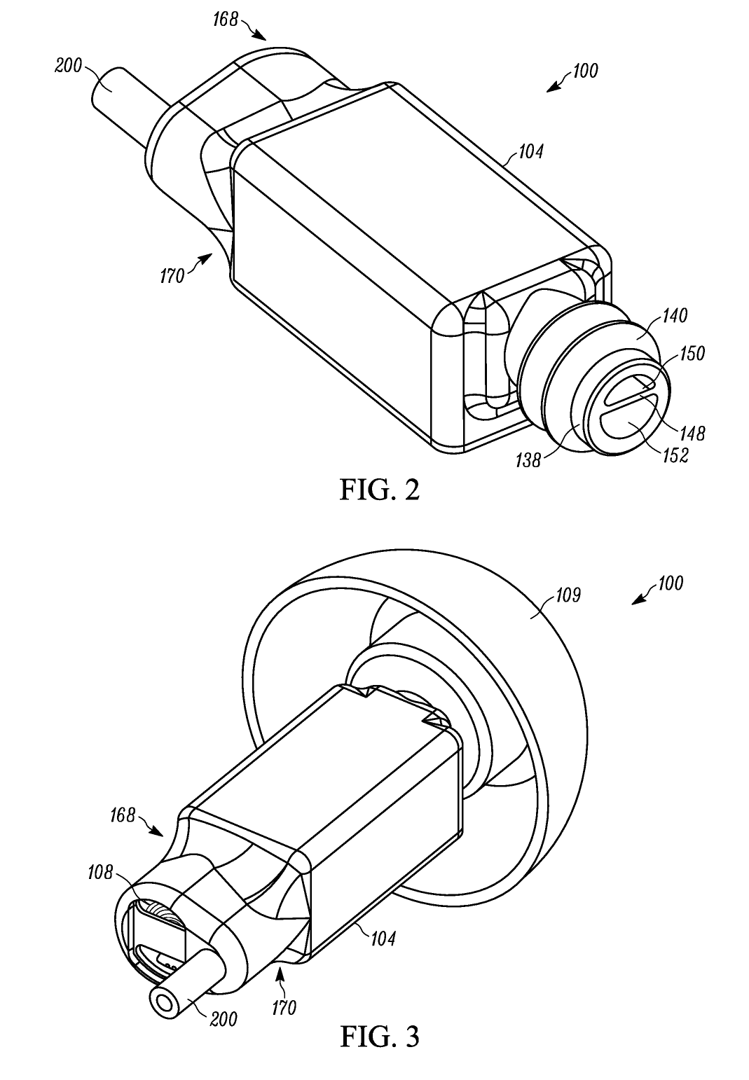

In FIGS. 2 and 3, the housing 104 is coupled to a tube 200 which contains the wires 137 protruding from the acoustic transceiver 102. In more complex embodiments, the hearing device 100 may include an integrated circuit (IC) that controls the valve 108. In other embodiments, the device may include a microphone that requires additional signals and wires to transmit through the tube 200. In some embodiments, the set of wires 137 includes at least two wires to control the acoustic transducer 102 and at least two additional wires to control the valve 108.

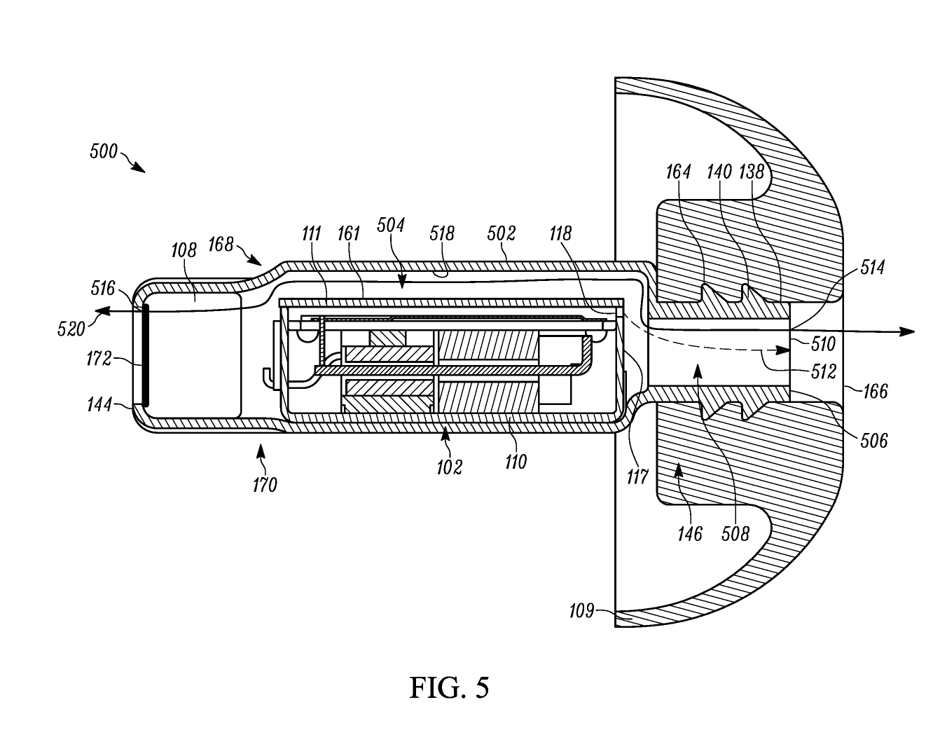

FIG. 5 shows a hearing device 500 in which the forward acoustic housing portion 146 is devoid of the partition 148 shown in FIG. 1. In this example, the hearing device 500 is made up of the acoustic transducer 102, a housing 502, an acoustic vent 504, the actuatable acoustic valve 108, and the ear dome 109.

The housing contains the acoustic transducer 102 and the acoustic valve 108. In this example, volume 508 of the forward acoustic housing portion 146 defines a sound opening 510 located on the first end portion 506 of the housing, and also defines an acoustic path 512 located between the sound port 118 of the transducer and the sound opening 510 of the housing 502. As such, when the first portion of the hearing device is at least partially disposed in the user's ear canal, sound from the front volume 116 emanates along the acoustic path 512 into the user's ear canal via the sound opening 510.

The acoustic vent 504 of the hearing device 500 has a first port 514 and a second port 516, located opposite of each other inside the housing 502. When the first portion 506 is at least partially disposed in the user's ear canal, the first port 514 of the acoustic vent 504 is acoustically coupled to the ear canal, while the second port 516 of the acoustic vent 504 is coupled to the ambient atmosphere. The acoustic vent 504 is defined by the volume between an inside surface 518 of the housing 502 and the outer surface 161 of the transducer housing 110, as well as the volume 508 of the forward acoustic housing portion 508 of the housing 502. In FIG. 5, a flow path 520 of the acoustic vent 504 is indicated with a double-headed arrow. The acoustic valve 108 is disposed along the acoustic vent 504, so that when the acoustic valve 108 is actuated, the valve 108 can alter the passage of sound between the ear canal and the ambient atmosphere via the acoustic vent 504.

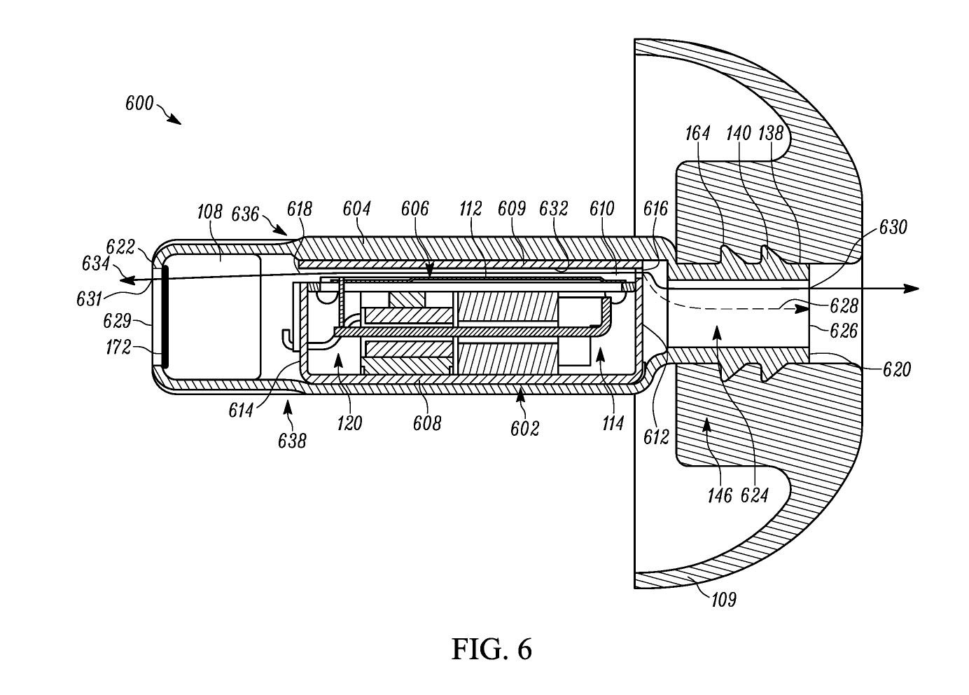

FIG. 6 shows a hearing device 600 having an acoustic vent disposed through the front volume and partially defined by the transducer housing and a diaphragm of the transducer. This configuration eliminates the acoustic vent between the housing and the transducer housing thereby reducing the overall sectional size of the hearing device or providing more space to accommodate a larger electro-acoustic transducer. The axial alignment of the valve and the transducer also contributes to a reduced sectional area of the hearing device. The hearing device 600 includes an acoustic transducer 602, a housing 604, an acoustic vent 606, an actuatable acoustic valve 108, and the ear dome 109.

In FIG. 6, the acoustic transducer 602 includes a transducer housing 608 with a cover 609 and a diaphragm 112 which separates an inside volume of the transducer housing into a back volume 114 and a front volume 610. The transducer includes the motor 120 disposed in the back volume 114 to actuate the diaphragm as discussed herein.

In FIG. 6, the transducer housing 608 includes a first end portion 612 and a second end portion 614, both of which are on the opposite sides of each other. The first end portion 612 and the cover 609 define a first sound port 616 that is acoustically coupled to the ear canal once the hearing device 600 is at least partially inserted into the ear. The second end portion 614 and the cover 609 define a second sound port 618. The front volume 610 is acoustically coupled to both the first sound port 616 and the second sound port 618.

The housing 604 has a first end portion 620 at least partially disposed in the user's ear canal and a second end portion 622 on the opposite side coupled to the ambient atmosphere. In this example, volume 624 of the forward acoustic housing portion 146 defines a sound opening 626 located on the first end portion 620 of the housing 604, and also defines an acoustic path 628 (indicated with a single-headed arrow) located between the sound port 616 of the transducer 102 and the sound opening 626 of the housing 604. The second end portion 622 of the housing 604 also has a vent opening 629. Furthermore, contoured transition portions 636 and 638, located between the transducer 602 and the valve 108, are formed in the housing 604.

The acoustic vent 606 is partially defined by the front volume 610 of the transducer 602 between the cover 609 of the transducer housing 608 and the diaphragm 112. The acoustic vent has a first port 630 as well as a second port 631, located opposite each other inside the housing 604. The front volume 610 is partly defined by the diaphragm 112 and an inside surface 632 of the cover 609. The front volume 610 is also partially defined by the first end portion 612 and the second end portion 614 of the transducer housing 608. When the first end portion 620 of the housing 604 is at least partially disposed in the user's ear canal, the first port 630 of the acoustic vent 606 is acoustically coupled to the ear canal, while the second port 631 of the acoustic vent 606 is coupled to the ambient atmosphere. In FIG. 6, a flow path 634 of the acoustic vent 606 is indicated with a double-headed arrow. The acoustic valve 108 is disposed in the vent opening 629 of the second end portion 622 of the housing 604, adjacent to the second end portion 614 of the transducer 602, so that when the acoustic valve 108 is actuated, the valve 108 can alter the passage of sound to and from the ear canal and the ambient atmosphere through the acoustic vent 606.

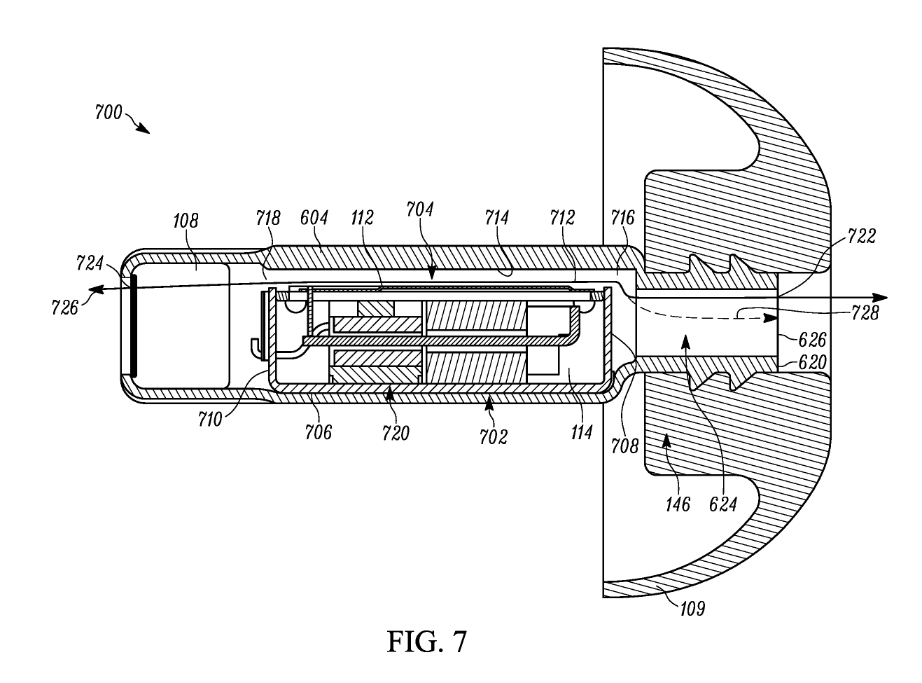

FIG. 7 shows a hearing device 700 wherein the housing 604 constitutes at least a portion of the transducer housing. In this embodiment, the acoustic vent 704 is partly defined by the diaphragm 112 and a portion 714 of the housing. Like other embodiments herein, the hearing device 700 also includes an acoustic transducer 702, an acoustic vent 704, the actuatable acoustic valve 108, and the close-fit ear dome 109.

In FIG. 7, the acoustic transducer 702 includes a transducer housing portion configured as a multi-sided cup 720 including a base portion 706 and side portions including a first end portion 708 and a second end portion 710. The diaphragm 112 disposed in the cup and defines a back volume 114 and a front volume 712 of the hearing device. The front volume 712 is defined in part by an inside surface 714 of the housing 604 and the diaphragm 112. The transducer housing 706 contains a first sound port 716 defined by the first end portion 708 and the inside surface 714 of the housing 604, and a second sound port 718 defined by the second end portion 710 and the inside surface 714 of the housing 604.

In FIG. 7, the acoustic vent 704 passes through the front volume 712 of the transducer 702. The vent has a first port 722 as well as a second port 724, located opposite of each other inside the housing 604. When the first end portion 620 of the housing 604 is at least partially disposed in the user's ear canal, the first port 722 of the acoustic vent 704 is acoustically coupled to the ear canal, while the second port 724 of the acoustic vent 704 is coupled to the ambient atmosphere. The acoustic vent 704 is partially defined by the volume between the inside surface 714 of the housing 604 and the diaphragm 112, and also partially defined by the volume 624 of the forward acoustic housing portion 146. A flow path 726 of the acoustic vent 704 is indicated with a double-headed arrow. Furthermore, an acoustic path 728 is defined by the volume 624 of the forward acoustic housing portion 146 and the first sound port 716, extending from the first sound port 716 to the sound opening 626.

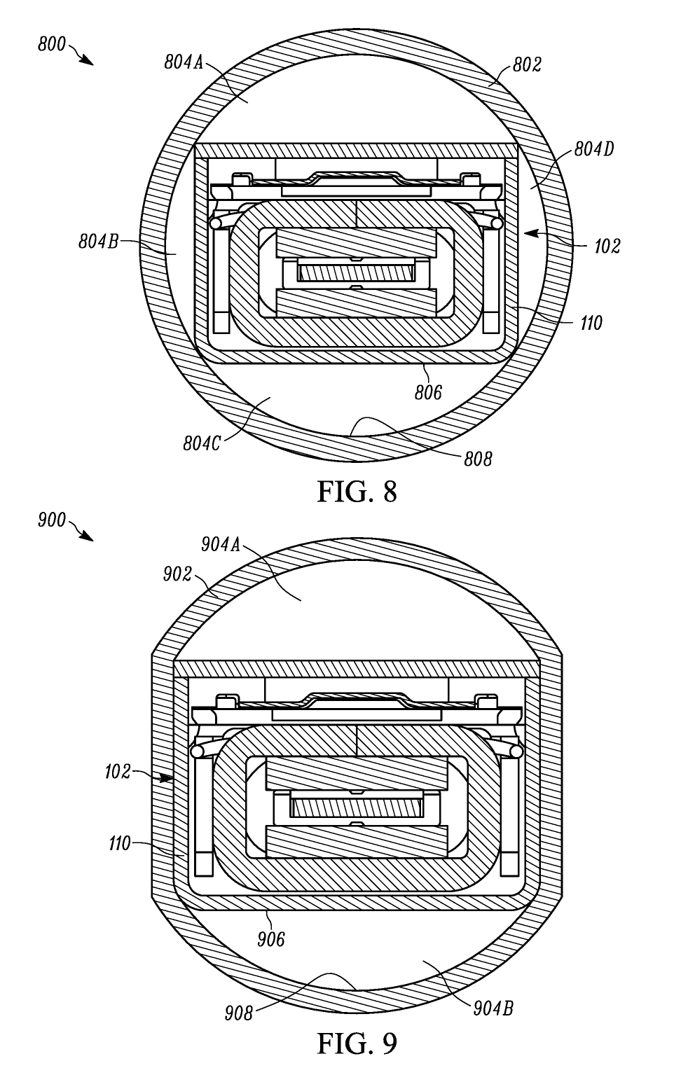

FIGS. 8 and 9 are sectional views of hearing devices 800 and 900, respectively, having multiple flow paths defined partly by the transducer. In both embodiments, in one example, the multiple flow paths merge before the sound opening at one end of the hearing device and before the acoustic valve at another end of the hearing device. In another example, the multiple flow paths may be truncated by the acoustic valve so that the flow paths effectively merge inside the body of the acoustic valve. The multiple paths generally reduce restriction of air flow through the hearing device in as much as they allow for multiple parallel paths of flow rather than a single path of higher overall resistance.

In FIG. 8, the hearing device 800 includes the acoustic transducer 102, a housing 802, and an acoustic vent 804 having four discrete flow paths 804A, 804B, 804C, and 804D around the transducer housing 110. Each of the flow paths 804A to 804D is defined by the outer surface 806 of the transducer housing 110 of the acoustic transducer 102 and the inner surface 808 of the housing 802. In FIG. 9, the hearing device 900 includes the acoustic transducer 102, a housing 902, and an acoustic vent 904 having two discrete flow paths 904A and 904B around the transducer housing 110. Each of the flow paths 904A and 904B is defined by the outer surface 906 of the transducer housing 110 of the acoustic transducer 102 and the inner surface 908 of the housing 902.

Although the examples in FIGS. 8 and 9 have four and two discrete flow paths, respectively, it will be understood that any number of flow paths may be possible by modifying the shape and/or size of the housing, or by adding any number of partitions within the volume formed between the transducer housing and the housing, as deemed as appropriate by a person with ordinary skills in the art.

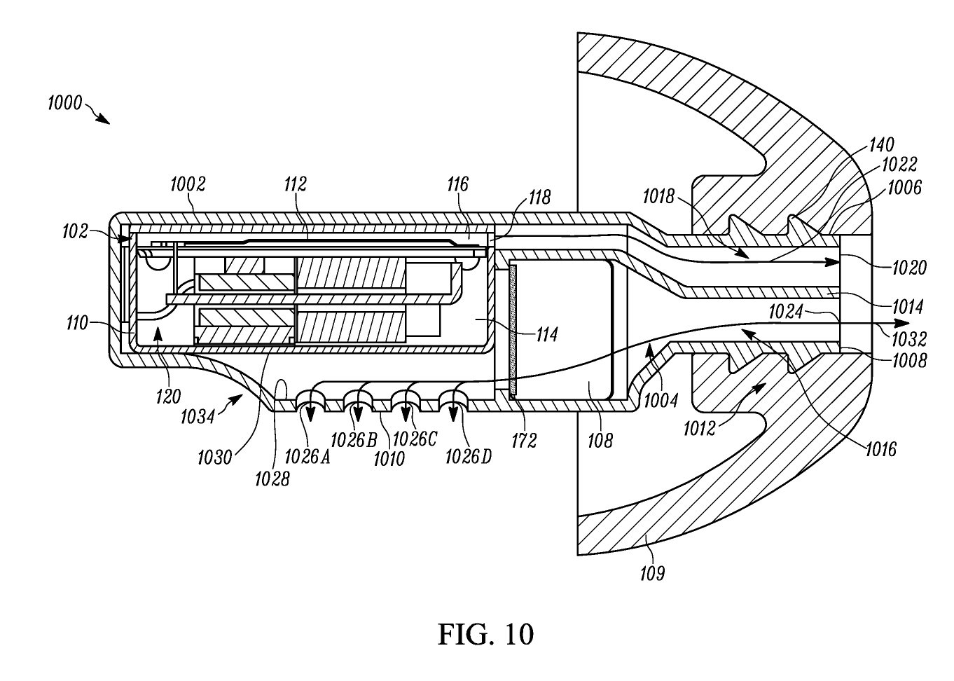

FIG. 10 illustrates another example of a hearing device 1000 in which there are multiple paths for the acoustic vent. In this example, the hearing device 1000 includes the acoustic transducer 102, a housing 1002, an acoustic vent 1004, the acoustic valve 108, and the ear dome 109. The housing 1002 includes a portion called a nozzle 1006 with one or more barbs 140 to which the ear dome 109 is fixedly attached. The housing 1002 has a first portion 1008 and a second portion 1010. The housing 1002 has a forward acoustic housing portion 1012 which includes a partition 1014 which separates the volume inside the forward acoustic housing portion 1012 into a first volume 1016 and a second volume 1018. The second volume 1018 defines a sound opening 1020 located on the first portion 1008 of the housing 1002. The second volume 1018 also defines an acoustic path 1022 (indicated with a single-headed arrow in FIG. 10) located between the sound port 118 of the transducer 102 and the sound opening 1020. As such, when the first portion 1008 is at least partially disposed in the user's ear canal, sound from the front volume 116 emanates along the acoustic path 1022 into the user's ear canal via the sound opening 1020.

In FIG. 10, the acoustic vent 1004 has a first port 1024 and a plurality of second ports 1026. In this example, there are four downwardly facing second ports 1026A, 1026B, 1026C, and 1026D, located to permit venting the user's ear canal to the ambient atmosphere. The shapes and sizes of the second ports 1026 are defined by the second portion 1010 of the housing 1002. When the first portion of the hearing device is at least partially disposed in the user's ear canal, the first port 1024 of the acoustic vent 1004 is acoustically coupled to the ear canal, while the second ports 1026 of the acoustic vent 1004 are coupled to the ambient atmosphere. The acoustic vent 1004 is defined by the volume between the inside surface 1028 of the housing 1002 and the outer surface 1030 of the transducer housing 110, as well as the first volume 1016 of the forward acoustic housing portion 1012 of the housing 1002. A flow path 1032 of the acoustic vent 1004 is indicated with a double-headed arrow. The acoustic valve 108 is placed along the acoustic vent 1004, so that when the acoustic valve 108 is actuated, the valve 108 can alter the passage of sound between the ear canal and the ambient atmosphere. A contoured transition portion 1034 located between the transducer 102 and the second ports 1026 also partially define a volume of the acoustic vent 1004 from the valve 108 to the second ports 1026. As illustrated (and as also shown in FIG. 1) the valve 108 is arranged in-line with the acoustic transducer 102. In this example, the valve 108 is interposed between the acoustic transducer 102 and the nozzle 1006, whereas in FIG. 1, acoustic transducer 102 is interposed between the valve 108 and the nozzle 138.

Although the example in FIG. 10 has four second ports for the acoustic vent, it will be understood that any number of ports may be possible by modifying the housing, as deemed by appropriate by a person with ordinary skills in the art. The filter 172 is mountable either internally within the housing 1002 between the acoustic valve 108 and the second portion 1010 of the housing 104, or externally for easy replacement, or in both locations. Also, in one example, the filter 172 may be mounted directly to the valve 108, the second portion 1010, or both, as deemed appropriate. In another example, the filter 172 may be located between the valve 108 and the first portion 1024, in order to protect both the vent path 1004 at the first portion 1024 and the acoustic path 1022 at the sound opening 1020. In yet another example, a plurality of filters may be employed, in which up to four filters may be placed in the following locations: at the second ports 1026, on one end of the valve 108 acoustically coupled to the ambient atmosphere as illustrated in FIG. 10, on the other end of the valve 108 acoustically coupled to the user's ear canal, and at the end of the nozzle 1006 where the first port 1024 of the acoustic vent 1004 and the sound opening 1020 are located.

The multiple acoustic vent paths decrease flow resistance within the acoustic vent and enable more air and sound from the ambient atmosphere to reach the ear canal, although other advantages may also be provided. Also, each of the multiple paths can act as a backup vent path in the event that one or more of the other paths gets clogged due to any foreign substance entering the path.

When the user prefers to have an open fitting, the valve included in the hearing device can be opened mechanically or electronically, thereby reducing at least some of the occlusion effects and allowing desirable external sounds from the ambient atmosphere to pass into the user's ear. If an electronic valve is employed, the opening and closing of the valve can be controlled by a variety of means including but not limited to user input to the hearing device, user input to a remote device, user input to a wired device, and adaptively by algorithm in the device or in a connected master device (e.g., a cell phone) based on how the hearing device is used.

While the present disclosure and what is presently considered to be the best mode thereof has been described in a manner that establishes possession by the inventors and that enables those of ordinary skill in the art to make and use the same, it will be understood and appreciated that there are many equivalents to the exemplary embodiments disclosed herein and that myriad modifications and variations may be made thereto without departing from the scope and spirit of the disclosure, which is to be limited not by the exemplary embodiments but by the appended claims.

1. A hearing device comprising:
a housing having a portion configured to be disposed at least partially in a user's ear canal;
an acoustic transducer disposed in the housing, the transducer including a diaphragm separating a volume internal to the housing into a back volume and a front volume;
a sound opening of the housing acoustically coupled to the front volume, wherein sound from the front volume emanates into the user's ear canal via the sound opening when the portion of the housing is at least partially disposed in the user's ear canal;
an acoustic vent having a first port acoustically coupled to a volume defined by the user's ear canal when the portion of the housing is at least partially disposed in the user's ear canal, the acoustic vent having a second port coupled to ambient atmosphere when the portion of the housing is at least partially disposed in the user's ear canal, the acoustic vent defined at least partially by a portion of the transducer;
an acoustic valve disposed along the acoustic vent,
wherein the acoustic valve is actuatable to alter passage of sound through the acoustic vent.

2. The device of claim 1, the transducer includes a transducer housing, the diaphragm is disposed in the transducer housing, the acoustic vent is disposed between the transducer housing and the housing, wherein an outer surface of the transducer housing defines at least a portion of the acoustic vent.

3. The device of claim 2, wherein the front volume is acoustically coupled to a sound port of the transducer and the housing includes a forward acoustic housing portion defining the sound opening of the housing, a volume of the forward acoustic housing portion defining a portion of the acoustic vent, and the volume of the forward acoustic housing portion defining an acoustic path between the sound port of the transducer and the sound opening of the housing.

4. The device of claim 3 further comprising a partition separating the volume of the forward acoustic housing portion into a first volume and a second volume, wherein the first volume is a portion of the acoustic vent and the second volume is at least a portion of the acoustic path between the sound port of the transducer and the sound opening of the portion of the housing.

5. The device of claim 2, the acoustic vent includes multiple discrete paths, each path defined at least partially by a corresponding portion of the transducer.

6. The device of claim 2, the transducer includes a motor disposed in the back volume.

7. The device of claim 6, the transducer is a balanced armature receiver, the motor including an armature linked to a movable portion of the diaphragm.

8. The device of claim 1, wherein the housing includes a forward acoustic housing portion defining the sound opening, the device including an ear dome coupled to a portion of the housing, the ear dome having a portion configured to substantially form an acoustic seal with a user's ear canal.

9. The device of claim 2, wherein the housing includes a first end portion and a second end portion opposite the first end portion, the sound opening disposed on the first end portion of the housing, the first end portion of the acoustic vent acoustically coupled to the sound opening of the housing, the acoustic valve disposed in an opening of the second end portion of the housing.

10. The device of claim 1, the acoustic vent passes through the front volume of the hearing device, wherein the diaphragm defines a portion of the acoustic vent.

11. The device of claim 10, the transducer includes a transducer housing, the diaphragm is disposed in the transducer housing and the front volume is defined in part by the diaphragm and a portion of the transducer housing, wherein the acoustic vent is further defined at least partially by a portion of the transducer.

12. The device of claim 11, wherein the transducer housing includes a first end portion and a second end portion opposite the first end portion, a first sound port disposed through the first end portion of the transducer housing and a second sound port disposed through the second end portion of the transducer housing, wherein the acoustic valve is disposed in the housing adjacent the second end portion of the transducer.

13. The device of claim 10, the transducer includes a motor disposed in the back volume.

14. The device of claim 13, the transducer is a balanced armature receiver, the motor including an armature linked to a movable portion of the diaphragm.

15. The device of claim 10, wherein the housing includes a forward acoustic housing portion defining the sound opening, the hearing device including an ear dome coupled to a portion of the housing, the ear dome having a portion configured to contact a user's ear canal.

16. The device of claim 10, a portion of the housing forms at least a portion of the front volume, wherein the acoustic vent is further defined by the portion of the housing forming the front volume.

17. The device of claim 16, the transducer includes a cup supporting the diaphragm and defining the back volume.

18. The device of claim 16, wherein the housing includes a first end portion and a second end portion opposite the first end portion, the sound opening disposed on the first end portion of the housing, the first port of the acoustic vent acoustically coupled to the sound opening of the housing, the acoustic valve disposed in an opening of the second end portion of the housing.
